(19) United States
(12) Patent Application Publication
(10) Pub. No.: US 2017/0178210 A1
(43) Pub. Date: Jun. 22, 2017

(54) DEVICE, SYSTEM AND METHOD FOR A MOBILE MECHANIC

(71) Applicant: Tharaa GAZZAZ, Houston, TX (US)

(72) Inventor: Tharaa GAZZAZ, Houston, TX (US)

(21) Appl. No.: 14/978,134

(22) Filed: Dec. 22, 2015

(51) Int. Cl. G06Q 30/06; G06Q 50/00

(52) U.S. Cl. CPC G06Q 30/0611; G06Q 50/01; G06Q 30/0639

(57) ABSTRACT

A mobile mechanic system can include a network communicably coupling a user device and at least one mechanic device. The user can transmit a request for a mechanic including details of the request. One or more mechanics can view the request and submit a cost corresponding to completing the project in the form of a bid, thereby creating the opportunity for multiple mechanics to place competitive bids. The user can view the bids and the associated mechanic profile and select a mechanic with whom the user would like to work.

### GRANT OF NON-EXCLUSIVE RIGHT

This application was prepared with financial support from the Saudi Arabian Cultural Mission, and in consideration therefore the present inventor(s) has granted The Kingdom of Saudi Arabia a non-exclusive right to practice the present invention.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Vehicle repair is a specialized field that can require years of training and experience. Vehicle repair can also be expensive depending on the required maintenance. However, much of the cost can be attributed to the cost of the labor for the mechanic. Without the specialized training and/or years of experience, repairing known issues and identifying unknown issues can be difficult.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

According to embodiments of the disclosed subject matter, a mobile mechanic system can include a network communicably coupling a user device and at least one mechanic device. The user can post a request for a mechanic including details of the request. One or more mechanics can view the request and submit a cost of completing the project in the form of a bid, thereby creating the opportunity for multiple mechanics to place competitive bids. The user can view the bids and the associated mechanic profile and select a mechanic with whom the user would like to work.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 depicts an exemplary overview of a mobile mechanic system.

FIG. 2 depicts an exemplary hardware description for the user device.

FIG. 3 depicts an exemplary view of a mechanic device displaying a mechanic profile.

FIG. 4 depicts an exemplary view of a user device displaying a user profile.

FIG. 5 depicts an exemplary view of a mechanic device displaying user requests for a mechanic.

FIG. 6 depicts an exemplary view of a user device displaying bids and corresponding mechanic profiles.

FIG. 7 is a flowchart depicting an exemplary method of making a request for a mechanic.

FIG. 8 is a flowchart depicting an exemplary method of bidding on a request for a mechanic.

FIG. 9 is a flowchart depicting an exemplary method of matching a user with a mechanic.

FIG. 10 depicts an exemplary hardware description of a server.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

Referring now to the drawings, wherein like reference numerals designate identical or corresponding parts throughout the several views.

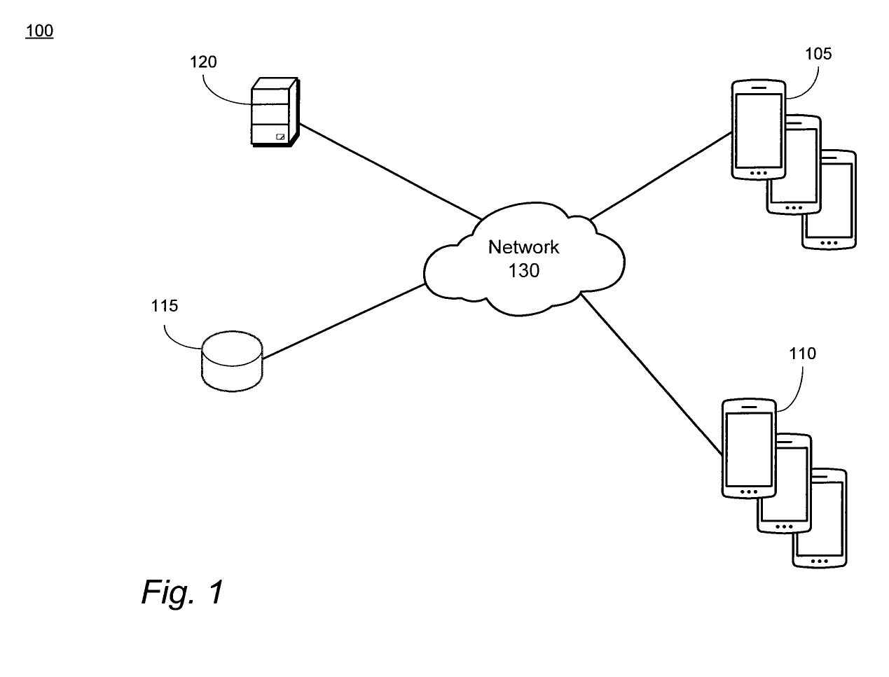

FIG. 1 depicts a mobile mechanic system 100. The mobile mechanic system 100 can include one or more user devices 105, at least one mechanic device 110, a database 115, and a server 120 communicably coupled to a network 130.

The user device 105 can be a smart device including a smart phone, a laptop, a computer, a tablet, a PDA, and the like. The user device 105 can be communicably coupled to the at least one mechanic device 110, the database 115, and the server 120. The user device 105 can submit a request for a mechanic, wherein the request can include information such as more details of the request for a mechanic as further described herein.

The at least one mechanic device 110 can be communicably coupled to the user device 105, the database 115, and the server 120. The at least one mechanic device 110 can be a smart phone, a laptop, a computer, a tablet, a PDA, and the like. The at least one mechanic device 110 can receive a request for a mechanic from the user device 105 and submit a bid corresponding to a cost of services to be agreed upon via the at least one mechanic device 110 and the user device 105.

The database 115 can store various information corresponding to the user device 105 and the at least one mechanic device 110. The database 115 can store transaction history between the user device 105 and the at least one mechanic device 110, one or more user profiles as further described herein, one or more mechanic profiles as further described herein, and the like to assist with the functionality of the mobile mechanic system 100. Each user profile and mechanic profile stored in the database 115 can be associated with a user device 105 and a mechanic device 110, respectively.

The server 115 can receive signals from the user device 105 and the at least one mechanic device 110 to cause the server 115 to match a user device 105 with at least one mechanic device 110 based on a selection by the user device 105. The server 115 can facilitate various processing for the mobile mechanic system 100 as further described herein.

The network 130 can be a public network, such as the Internet, or a private network such as an LAN or WAN network, or any combination thereof and can also include PSTN or ISDN sub-networks. The network 130 can also be wired, such as an Ethernet network, or can be wireless such as a cellular network including EDGE, 3G and 4G wireless cellular systems. The wireless network can also be WiFi, Bluetooth, or any other wireless form of communication that is known.

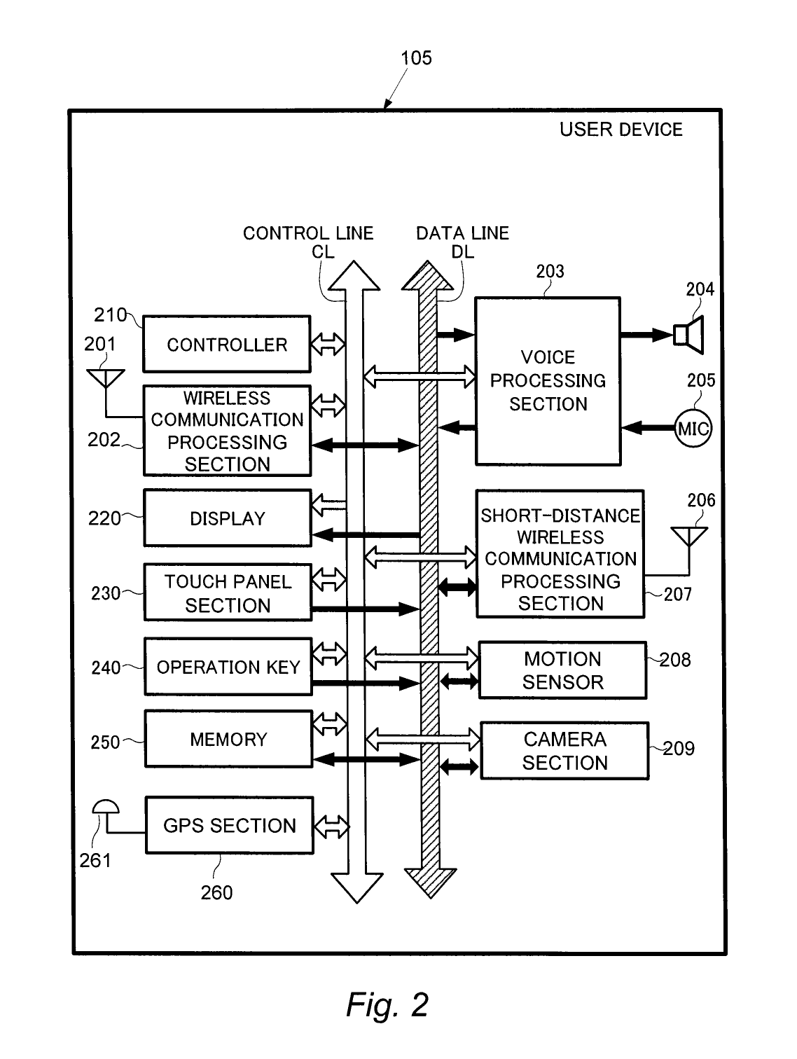

FIG. 2 is a detailed block diagram illustrating an exemplary user device 105 according to certain embodiments of the present disclosure. In certain embodiments, user device 105 may be a smart phone. The functionality of various features described herein can be implemented via an application running on the mobile device, such as the user device 105. However, one of ordinary skill in the art will appreciate that the features described herein may be adapted to be implemented on other devices (e.g., a laptop, a tablet, a server, an e-reader, a camera, a navigation device, etc.). The exemplary user device 105 of FIG. 2 includes a controller 210 and a wireless communication processor 202 connected to an antenna 201. A speaker 204 and a microphone 205 are connected to a voice processor 203.

The controller 210 is an example of a control circuit and may include one or more Central Processing Units (CPUs), and may control each element in the user device 105 to perform functions related to communication control, audio signal processing, control for the audio signal processing, still and moving image processing and control, and other kinds of signal processing. The controller 210 may perform these functions by executing instructions stored in a memory 250. Alternatively or in addition to the local storage of the memory 250, the functions may be executed using instructions stored on an external device accessed on a network 230 or on a non-transitory computer readable medium.

The memory 250 can include Read Only Memory (ROM), Random Access Memory (RAM), or a memory array including a combination of volatile and non-volatile memory units. The memory 250 may be utilized as working memory by the controller 210 while executing the processes and algorithms of the present disclosure. Additionally, the memory 250 may be used for long-term storage, e.g., of image data and information related thereto. The memory 250 may be configured to store the battle view information, operation view information and list of commands.

The user device 105 includes a control line CL and data line DL as internal communication bus lines. Control data to/from the controller 210 may be transmitted through the control line CL. The data line DL may be used for transmission of voice data, display data, etc.

The antenna 201 transmits/receives electromagnetic wave signals between base stations for performing radio-based communication, such as the various forms of cellular telephone communication. The wireless communication processor 202 controls the communication performed between the user device 105 and other external devices via the antenna 201. For example, the wireless communication processor 202 may control communication between base stations for cellular phone communication.

The speaker 204 emits an audio signal corresponding to audio data supplied from the voice processor 203. The microphone 205 detects surrounding audio and converts the detected audio into an audio signal. The audio signal may then be output to the voice processor 203 for further processing. The voice processor 203 demodulates and/or decodes the audio data read from the memory 250 or audio data received by the wireless communication processor 202 and/or a short-distance wireless communication processor 207. Additionally, the voice processor 203 may decode audio signals obtained by the microphone 205.

The exemplary user device 105 may also include a display 220, a touch panel 230, an operation key 240, and a short-distance communication processor 207 connected to an antenna 206. The display 220 may be a Liquid Crystal Display (LCD), an organic electroluminescence display panel, or another display screen technology. In addition to displaying still and moving image data, the display 220 may display operational inputs, such as numbers or icons which may be used for control of the user device 105. The display 220 may additionally display a GUI for a user to control aspects of the user device 105 and/or other devices. Further, the display 220 may display characters and images received by the user device 105 and/or stored in the memory 250 or accessed from an external device on the network 130. For example, the user device 105 may access the network 130 such as the Internet and display text and/or images transmitted from a Web server.

The touch panel 230 may include a physical touch panel display screen and a touch panel driver. The touch panel 230 may include one or more touch sensors for detecting an input operation on an operation surface of the touch panel display screen. The touch panel 230 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 230 may detect when the stylus approaches/contacts the operation surface of the touch panel display (similar to the case in which a finger is used for the touch operation).

In certain aspects of the present disclosure, the touch panel 230 may be disposed adjacent to the display 220 (e.g., laminated) or may be formed integrally with the display 220. For simplicity, the present disclosure assumes the touch panel 230 is formed integrally with the display 220 and therefore, examples discussed herein may describe touch operations being performed on the surface of the display 220 rather than the touch panel 230. However, the skilled artisan will appreciate that this is not limiting.

For simplicity, the present disclosure assumes the touch panel 230 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 230 may include transparent electrode touch sensors arranged in the X-Y direction on the surface of transparent sensor glass.

The touch panel driver may be included in the touch panel 230 for control processing related to the touch panel 230, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in certain embodiments, the touch panel 230 may detect a position of a user's finger around an edge of the display panel 220 (e.g., gripping a protective case that surrounds the display/touch panel). Signals may be transmitted by the touch panel driver, e.g. in response to a detection of a touch operation, in response to a query from another element based on timed data exchange, etc.

The touch panel 230 and the display 220 may be surrounded by a protective casing, which may also enclose the other elements included in the user device 105. In certain embodiments, a position of the user's fingers on the protective casing (but not directly on the surface of the display 220) may be detected by the touch panel 230 sensors. Accordingly, the controller 210 may perform display control processing described herein based on the detected position of the user's fingers gripping the casing. For example, an element in an interface may be moved to a new location within the interface (e.g., closer to one or more of the fingers) based on the detected finger position.

Further, in certain embodiments, the controller 210 may be configured to detect which hand is holding the user device 105, based on the detected finger position. For example, the touch panel 230 sensors may detect a plurality of fingers on the left side of the user device 105 (e.g., on an edge of the display 220 or on the protective casing), and detect a single finger on the right side of the user device 105. In this exemplary scenario, the controller 210 may determine that the user is holding the user device 105 with his/her right hand because the detected grip pattern corresponds to an expected pattern when the user device 105 is held only with the right hand.

The operation key 240 may include one or more buttons or similar external control elements, which may generate an operation signal based on a detected input by the user. In addition to outputs from the touch panel 230, these operation signals may be supplied to the controller 210 for performing related processing and control. In certain aspects of the present disclosure, the processing and/or functions associated with external buttons and the like may be performed by the controller 210 in response to an input operation on the touch panel 230 display screen rather than the external button, key, etc. In this way, external buttons on the user device 105 may be eliminated in lieu of performing inputs via touch operations, thereby improving water-tightness.

The antenna 206 may transmit/receive electromagnetic wave signals to/from other external apparatuses, and the short-distance wireless communication processor 207 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 207.

The user device 105 may include a motion sensor 208. The motion sensor 208 may detect features of motion (i.e., one or more movements) of the user device 105. For example, the motion sensor 208 may include an accelerometer to detect acceleration, a gyroscope to detect angular velocity, a geomagnetic sensor to detect direction, a geo-location sensor to detect location, etc., or a combination thereof to detect motion of the user device 105. In certain embodiments, the motion sensor 208 may generate a detection signal that includes data representing the detected motion. For example, the motion sensor 208 may determine a number of distinct movements in a motion (e.g., from start of the series of movements to the stop, within a predetermined time interval, etc.), a number of physical shocks on the user device 105 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 210, whereby further processing may be performed based on data included in the detection signal. The motion sensor 208 can work in conjunction with a Global Positioning System (GPS) section 260. The GPS section 260 detects the present position of the user device 105. The information of the present position detected by the GPS section 260 is transmitted to the controller 210. An antenna 261 is connected to the GPS section 260 for receiving and transmitting signals to and from a GPS satellite.

The user device 105 may include a camera section 209, which includes a lens and shutter for capturing photographs of the surroundings around the user device 105. In an embodiment, the camera section 209 captures surroundings of an opposite side of the user device 105 from the user. The images of the captured photographs can be displayed on the display panel 220. A memory section saves the captured photographs. The memory section may reside within the camera section 209 or it may be part of the memory 250. The camera section 209 can be a separate feature attached to the user device 105 or it can be a built-in camera feature.

It should be appreciated that the hardware description in FIG. 2 can also be the hardware description for the at least one mechanic device 110.

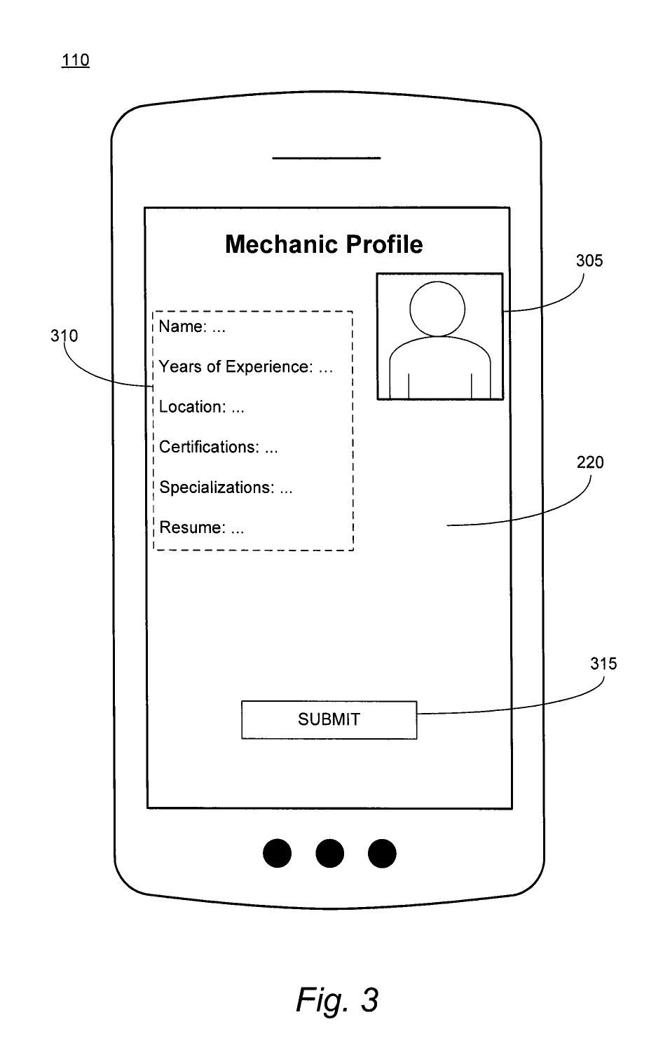

FIG. 3 depicts a mechanic device 110, according to one example. Therefore the features described herein relating to the mechanic device 110 can be applied to all mechanic devices 110. FIG. 3 depicts the mechanic device 110 displaying, via display 220, a mechanic profile. The mechanic profile can include a mechanic profile image 305, mechanic profile information 310, and an interaction button 315. The mechanic profile image 305 can be an image corresponding to the mechanic of the mechanic device 110. The mechanic profile information 310 can include a name associated with a mechanic of the mechanic device 110, years of experience, location, certifications, specializations, additional resume information, ratings, and the like. It should be appreciated that the location can refer to the location of the mechanic device 110 or the location of the mechanic's place of business if the mechanic has set a location for the mechanic's place of business. The interaction button 315 can be used to activate a signal to be sent to the server 120, for example. The interaction button can include the text “SUBMIT”, for example, referring to the mechanic submitting the mechanic profile to be stored in the database 110. However, it should be appreciated that any text can be displayed in the interaction button 315. Additionally, it should be appreciated that the interaction button 315 can perform a plurality of actions indicative of the environment of the interaction button 315. For example, the interaction button 315 can activate different functionality corresponding to the information the display 220 is displaying. The interaction button 315 may send a completed mechanic profile to the database 115 for storage, or the interaction button 315 may send a request to the server 120, for example.

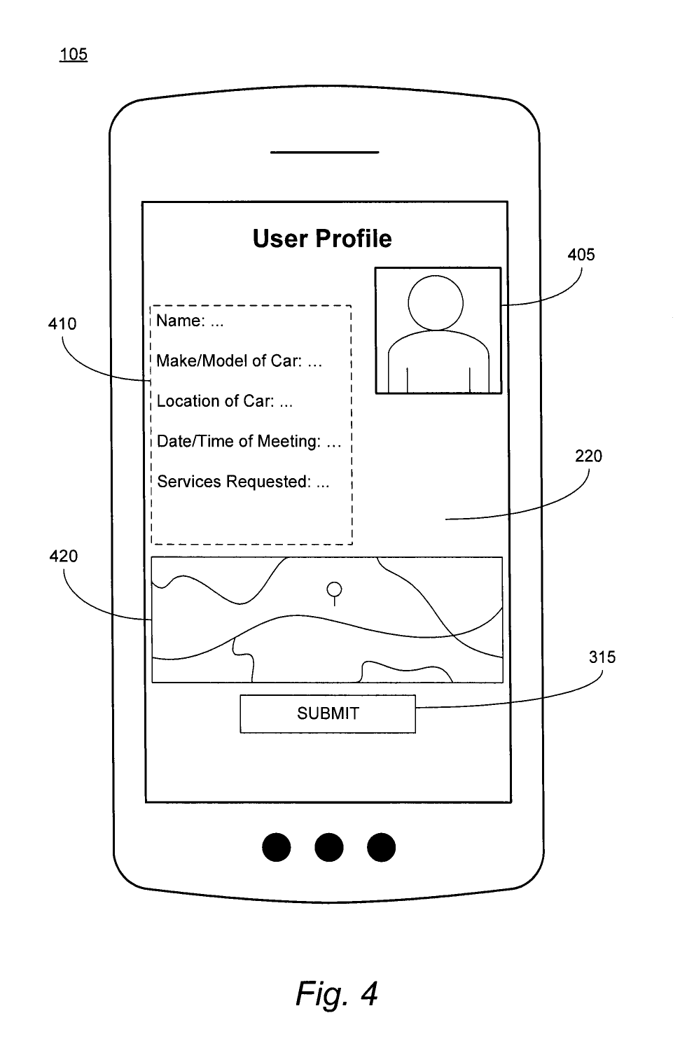

FIG. 4 depicts a user device 105 displaying, via display 220, a user profile. The user profile can include a user profile image 405, user profile information 410, the interaction button 315, and a map 420. The user profile image 405 can be an image corresponding to the user of the user device 105. The user profile information 410 can include a name of a user associated with the user device 105, a make and a model of a car that needs a mechanic's services, a location of the car, a date and a time of a meeting, services requested, and the like. The interaction button 315 can perform functionality similar to that described in FIG. 3. The map 420 can be displayed, via the display 220, with a location corresponding to the location of the car and/or meeting place described in the user profile information 410. The map 420 can be a Google Maps API, for example, integrated into the mobile mechanic system 100 to provide electronic map functionality for the user device 105 and the mechanic device 110 as would be known to one of ordinary skill in the art.

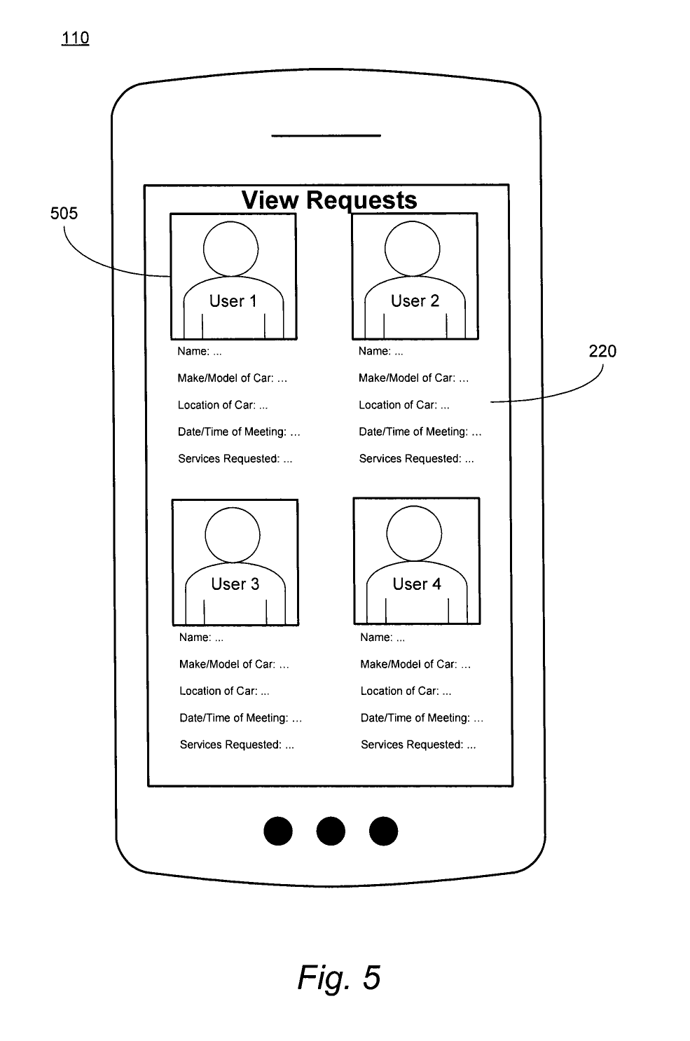

FIG. 5 depicts a mechanic device 110 displaying a user request 505. It should be appreciated that a plurality of user requests 505 can be displayed, via display 220, should a plurality of requests be available to display. The mechanic device 110 can display user requests 505 from users within a predetermined adjustable range of the current location of the mechanic device 110, or set a location of a mechanic's place of business, as determined by the GPS section 260. The mechanic device 110 can access the locations of the one or more user devices 105 requesting a mechanic from the database 115, for example, and compare the location of each user device 105 to the current location of the mechanic device 110, and/or the location of the mechanic's place of business, as would be known to one of ordinary skill in the art. The user request 505 can include the user profile information 410. The mechanic associated with the mechanic device 110 can view each user request 505 to determine if the request is within the mechanic's skill set, the location, if the date and time of the meeting do not conflict with the mechanic's schedule, and the like. Once the mechanic associated with the mechanic device 110 has reviewed the user request 505, the mechanic associated with the mechanic device 110 can place a bid via the mechanic device 110. The bid can be a predetermined amount of money, decided by the mechanic, the user of the user device 105 will have to pay for the mechanic's services. The predetermined amount of money can be determined by calculating various items such as, for example, cost of labor, estimated amount of time to complete the project, and cost of parts. Additionally, a time limit can be placed on the amount of time the user request 505 is active and available for bidding, such that after a predetermined amount of time, no more bids can be placed. Further, a placed bid can be modified prior to the bidding time limit being reached. For example, placing an additional bid can override the previously placed bid.

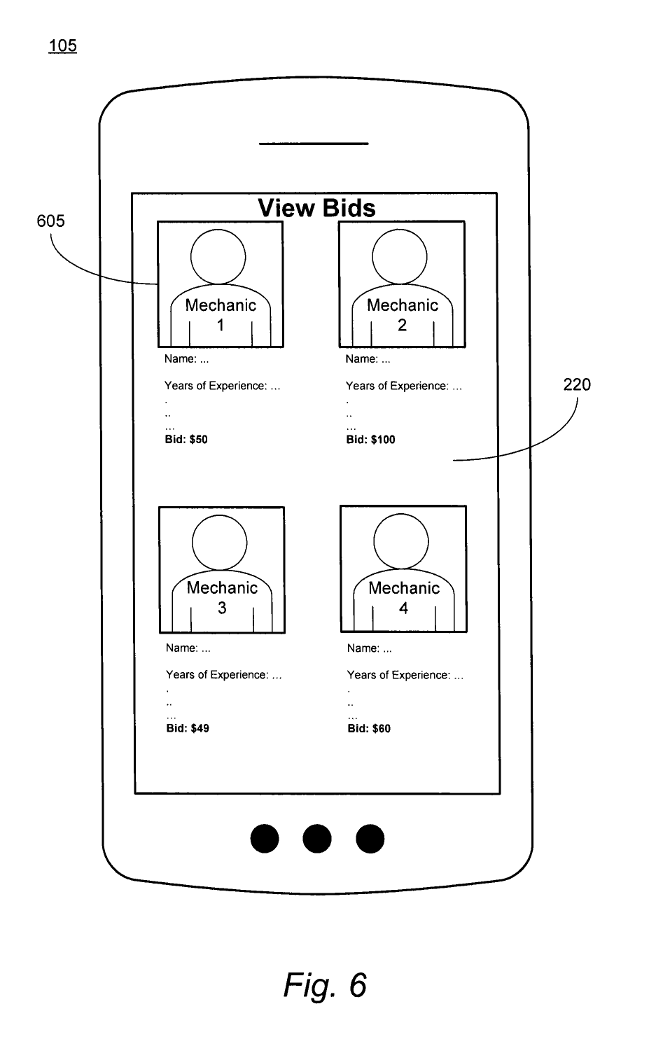

FIG. 6 depicts a user device 105 displaying a mechanic bid 605. The mechanic bid 605 can include the mechanic profile and the price of the bid associated with the mechanic profile. For example, Mechanic 1 bid $50, Mechanic 2 bid $100, Mechanic 3 bid $49, and Mechanic 4 bid $60. Mechanic 2 may have bid $100 because Mechanic 2 is a very experienced mechanic who wants to be charged more for cost of labor based on experience and/or a specialty that may correspond to the mechanical issue presented in the user profile. Additionally, Mechanic 3 may have similar experience to Mechanic 1 and can try to outbid Mechanic 1 by bidding $1 less than Mechanic 1 thus creating competitive pricing. Accordingly, the system 100 provides bids visibly to other mechanics, thereby ensuring better prices for the user. The user associated with the user device 105 can review the mechanic bids 605 and select a mechanic bid based on the price of the bid, the mechanic's experience and specializations, availability, location and the like.

It should be appreciated that all the content displayed by display 220 is intended to be exemplary and should not limit the content that can be displayed including the positioning, text, images, and the like.

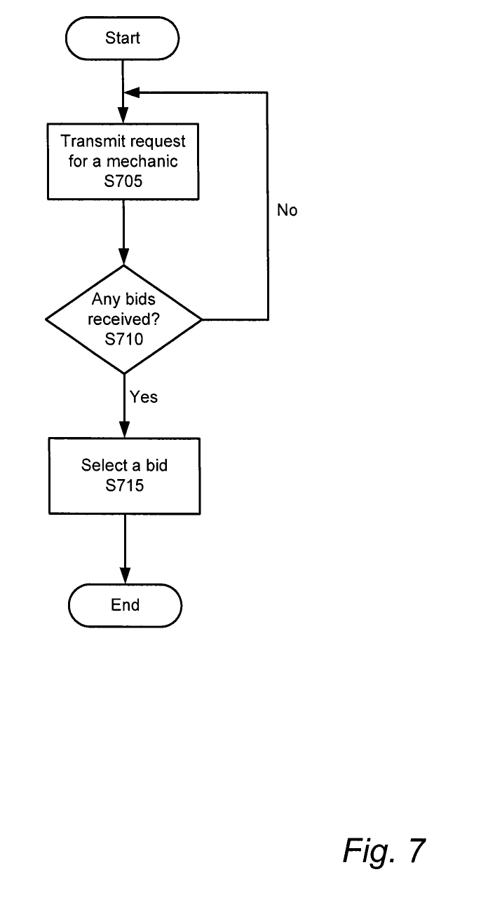

Next, FIG. 7 illustrates an exemplary algorithmic flowchart for performing a request for a mechanic according to one aspect of the present disclosure.

In S705, a request for a mechanic can be transmitted to the server 120 by the user device 105 to one or more mechanic devices 110. The one or more mechanic devices 110 can be selected to receive, from the server 120, a request based on location, for example, such that the location of the mechanic devices 110, or the location of the mechanic's place of business, selected to receive the request are within a predetermined distance of the location of the user device 105.

In S710, it can be determined if the user device 105 has received any bids on the request for a mechanic. If no bids have been received, the process can return to S705 to transmit a request for a mechanic. If one or more bids have been received, a bid can be selected in S715.

In S715, the user device 105 can select a bid that has been placed by the mechanic device 110. Once the user device 105 has selected a bid, the process can end.

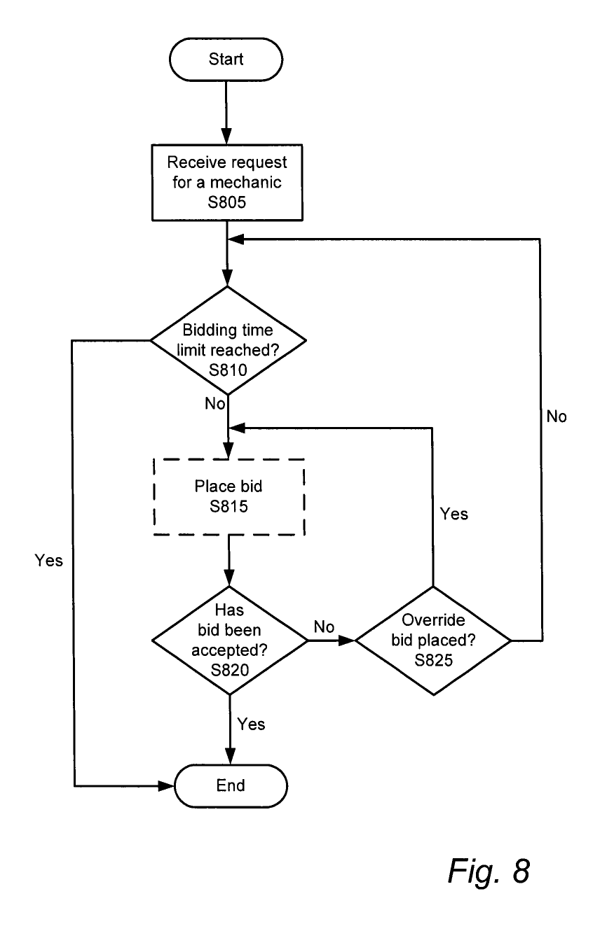

Next, FIG. 8 illustrates an exemplary algorithmic flowchart for bidding on a request for a mechanic according to one aspect of the present disclosure.

In S805, the mechanic device 110 can receive a request for a mechanic from the server 120. The request can be received from a user device 105 within a predetermined distance of the location of the mechanic device 110, or the location of the mechanic's place of business.

In S810, it can be determined if a bidding time limit has been reached. The bidding time limit can be a predetermined amount of time in which the mechanic device 110 can place a bid on a request for a mechanic. If the bidding time limit has been reached, then the process can end. If the bidding time limit has not been reached, then the mechanic device 110 can place a bid in S815.

In S815, the mechanic device 110 can place a bid on the request for a mechanic. S815 can be optional as the mechanic device is not always required to place a bid for each received request for a mechanic. Additionally, the mechanic device 110 may have already placed a bid and may choose not to place any additional bids that would override a previous bid.

In S820, it can be determined if the bid associated with the mechanic device 110 has been accepted by the user device 105. If the bid has not been accepted, then it can be determined if an override bid from another mechanic has been placed in S825. However, if the bid has been accepted, then the process can end.

In S825, it can be determined if an override bid has been placed. The override bid can override the previous bid placed by the mechanic if the bid time limit has not been reached and the user has not already accepted the previous bid. If an override bid has been placed, then the process can return to S815 to allow previous bids to be updated or new bids to be made. If the override bid has not been placed, then the process can return to S810 to determine if the bidding time limit has been reached, which could end the process should the bid placed by the mechanic device 110 not be accepted before the bidding time limit has been reached.

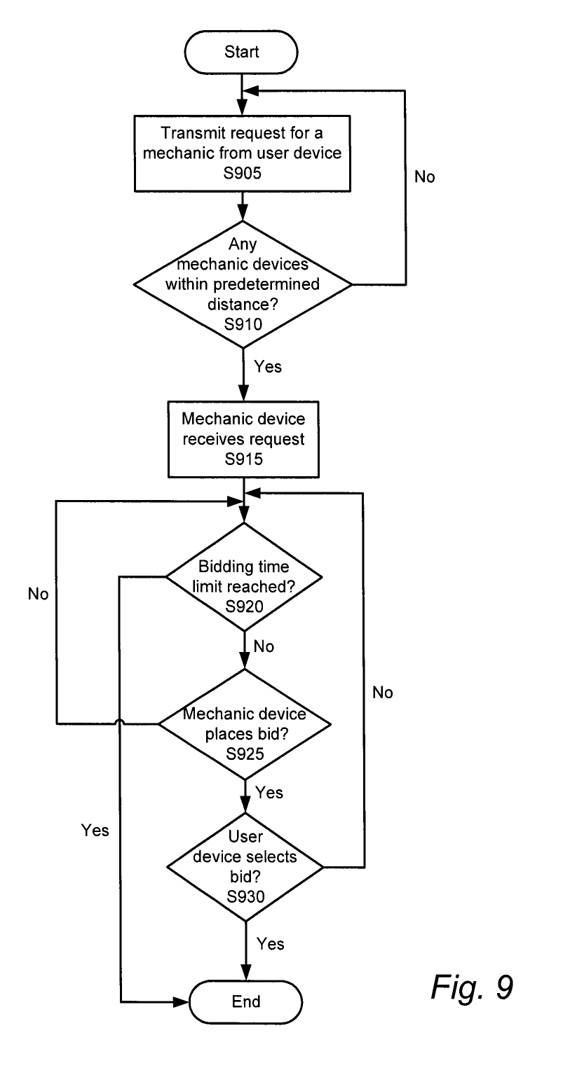

Next, FIG. 9 illustrates an exemplary algorithmic flowchart for matching a user with a mechanic according to one aspect of the present disclosure.

In S905, a request for a mechanic can be transmitted from the user device 105 to the mechanic device 110 via the network 130 and the server 120. The request can include parameters such as setting search criteria, including setting a predetermined distance, such that the mechanic device 110 should be within the predetermined distance, for example.

In S910, it can be determined if any mechanic devices 110, or the location of the mechanic's place of business if it has been previously set, are located within the predetermined distance of the location of the user device 105. The locations can be determined by the server 120 as the user device 105 and the at least one mechanic device 110, or the location of the mechanic's place of business, transmit a location to the server 120. If there are no mechanic devices 110, or any mechanic's place of business, within the predetermined distance, the process can return to S905 to transmit a new request. However, if there is at least one mechanic device 110, or any mechanic's place of business, within the predetermined distance then the mechanic device 110 can receive the request in S915.

In S915, the mechanic device 110 can receive the request for a mechanic from the user device 105.

In S920, it can be determined if the bidding time limit has been reached. The bidding time limit can be a predetermined amount of time in which the mechanic device 110 can place a bid on a request for a mechanic. If the bidding time limit has been reached, then the process can end. If the bidding time limit has not been reached, then it can be determined if one of the mechanic devices 110 have placed a bid in S925.

In S925, it can be determined if one of the mechanic devices 110 have placed a bid for the request for a mechanic. If it is determined that the mechanic device 110 has not placed a bid, then the process can return to S920 to continuously determine if the bidding time limit has been reached. If it is determined that the mechanic device 110 has placed a bid, then it can be determined if the user device 105 selects the bid in S930.

In S930, it can be determined if the user device 105 selects the bid made by the mechanic device 110. If the user device 105 has not selected the bid, then the process can return to S920 to determine if the bidding time limit has been reached. However, if the user device 105 has selected a bid, the process can end.

It should be appreciated that a rating system can be incorporated into the process of selecting a mechanic. For example, after a mechanic has completed a project for a user, the user can rate the mechanic based on timeliness, knowledge, success of the project, and the like. The mechanic's overall rating, an average of all ratings, for example, can be included in the mechanic profile information 310 to be viewed by the user device 110 when selecting a mechanic.

After the mobile mechanic system 100 matches the user device 105 with a mechanic device 110, the mobile mechanic system 100 can also facilitate a plurality of options for performing the task requested of the mechanic. For example, the user of the user device 105 can meet the mechanic associated with the mechanic device 110 at an agreed upon location where the user device 105 intends to purchase a used car. The mechanic can check the used car for any mechanical issues, run diagnostic tests, perform a standard safety inspection, and the like as would be known by one of ordinary skill in the art. Additionally, the mechanic could perform various tests virtually by viewing the vehicle in need of repair or inspection through the camera section 209 of the user device 105 and communicate via the wireless communication processing section 202 and the voice processing section 203, and the user device 105 can stream video content to the mechanic device 110 as would be known to one of ordinary skill in the art.

In an exemplary embodiment, the mobile mechanic system 100 can automatically receive a request for a mechanic, via the server 120 and the network 130, from an auto-diagnostic feature included in a vehicle. For example, an alert, such as a “check engine light” alert, may appear on a dash of a vehicle with a mechanical issue. The alert can cause a signal to be sent to the server 120 automatically requesting a mechanic. The signal can include information such as the mechanical issue that caused the alert to be delivered, the vehicle information, the vehicle owner information, and the like.

An advantage of the mobile mechanic system 100 can be that a car owner can select an individual mechanic within a predetermined distance based on various qualifying criteria, including ratings from previous users, rather than choosing a brand name mechanic shop. Further, an advantage is appealing to the on-demand economy. For example, in a situation where a user's car breaks down, an on-demand mechanic can assist virtually or in person before money is spent on a tow truck. Also, the mobile mechanic system 100 can create a knowledgeable resource. For example, a user can learn to change the oil in their vehicle by communicating virtually with a mechanic that has been matched with the user via the mobile mechanic system 100. The mechanic can walk the user through the process step by step via communication between the user device 105 and the mechanic device 110 so the user can perform the oil change independently in the future.

Further, the mobile mechanic system 100 improves car repair efficiency as the request for a mechanic can be on-demand. The mobile mechanic system eliminates inconvenient scheduling as a mechanic can be requested on-demand. Additionally, the mobile mechanic system 100 can reduce the need for tow trucks as the mechanic may be able to repair the car (via virtual communication and/or arriving at the location of the vehicle after the on-demand request for the mechanic) that may have previously needed a tow truck. Also, one-on-one communication between the mechanic and the user can also improve efficiency. The user, who may be unfamiliar with vehicle repair, can receive real-time updates from the one-on-one communication and make knowledgeable decisions with the help of the mechanic. The user can also ensure a fair price for the vehicle repair due to the competitive pricing that can be implemented by a special purpose computer, such as the server 130, implementing features that are not generic or well known, including the features of the mobile mechanic system 100 described above. Similarly, the auto-diagnostic alert transmitted automatically when the alert is delivered to the dash of the vehicle can be implemented by a special purpose computer, such as server 130, implementing features that are not generic or well known.

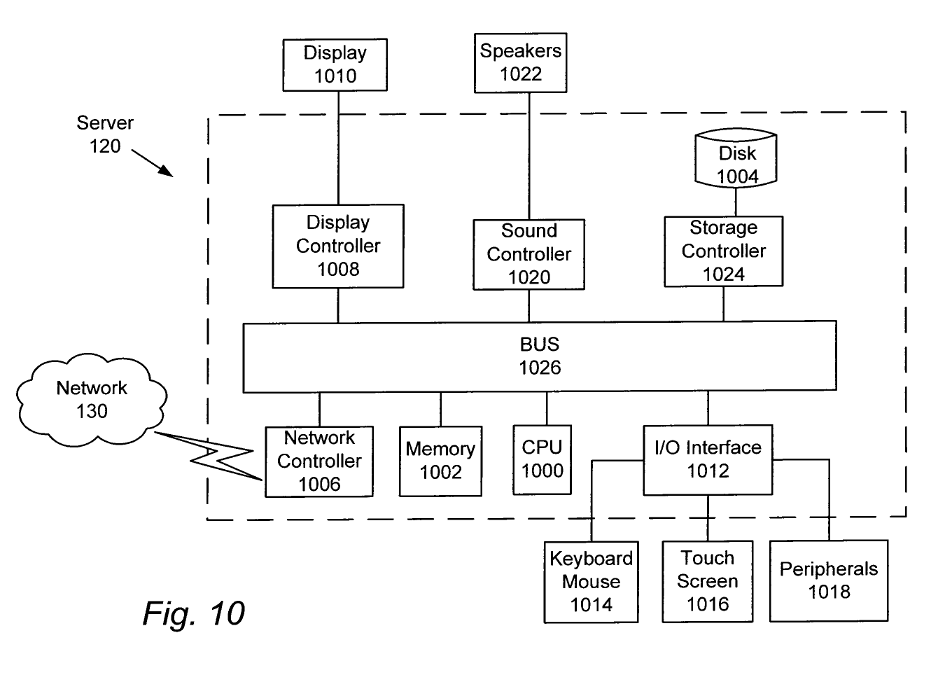

Next, a hardware description of the server 120 according to exemplary embodiments is described with reference to FIG. 10. In FIG. 10, the server 120 includes a CPU 1000 which performs the processes described herein. The process data and instructions may be stored in memory 1002. These processes and instructions may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 120 communicates, such as a server or computer.

Further, the claimed advancements may be provided as a utility application, background daemon, or component of an operating system, or combination thereof, executing in conjunction with CPU 1000 and an operating system such as Microsoft Windows 7, UNIX, Solaris, LINUX, Apple MAC-OS and other systems known to those skilled in the art.

The hardware elements in order to achieve the server 120 may be realized by various circuitry elements, known to those skilled in the art. For example, CPU 1000 may be a Xenon or Core processor from Intel of America or an Opteron processor from AMD of America, or may be other processor types that would be recognized by one of ordinary skill in the art. Alternatively, the CPU 1000 may be implemented on an FPGA, ASIC, PLD or using discrete logic circuits, as one of ordinary skill in the art would recognize. Further, CPU 1000 may be implemented as multiple processors cooperatively working in parallel to perform the instructions of the inventive processes described above.

The server 120 in FIG. 10 also includes a network controller 1006, such as an Intel Ethernet PRO network interface card from Intel Corporation of America, for interfacing with network 130. As can be appreciated, the network 130 can be a public network, such as the Internet, or a private network such as an LAN or WAN network, or any combination thereof and can also include PSTN or ISDN sub-networks. The network 130 can also be wired, such as an Ethernet network, or can be wireless such as a cellular network including EDGE, 3G and 4G wireless cellular systems. The wireless network can also be WiFi, Bluetooth, or any other wireless form of communication that is known.

The server 120 further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard.

A sound controller 1020 is also provided in the server 120, such as Sound Blaster X-Fi Titanium from Creative, to interface with speakers/microphone 1022 thereby providing sounds and/or music.

The general purpose storage controller 1024 connects the storage medium disk 1004 with communication bus 1026, which may be an ISA, EISA, VESA, PCI, or similar, for interconnecting all of the components of the server 120. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. Features of the disclosed embodiments can be combined, rearranged, omitted, etc., within the scope of the invention to produce additional embodiments. Furthermore, certain features may sometimes be used to advantage without a corresponding use of other features. Accordingly, Applicant(s) intend(s) to embrace all such alternatives, modifications, equivalents, and variations that are within the spirit and scope of the disclosed subject matter.

What is claimed is:

1. A server comprising:
circuitry configured to
receive an on-demand request from a user device for a mechanic to service a vehicle,
determine if at least one mechanic device is within a predetermined distance of a location of the user device,
transmit the request for the mechanic to service the vehicle to at least one local mechanic device corresponding to at least one mechanic device within the predetermined distance, wherein the request activates programming within the at least one local mechanic device within the predetermined distance to cause the at least one local mechanic device to display the request,
receive, from the at least one local mechanic device and in response to receiving the request, one or more bids to service the vehicle,
determine if a bidding time limit has been reached for the at least one local mechanic device within the predetermined distance,
transmit, in response to the bidding time limit being reached, the bids to the user device, which activates programming within the user device to cause the bids to display on the user device, and
receive a selection, from the user device and in response to receiving the bids, for one of the bids from the at least one mechanic device.

2. The server according to claim 1, wherein the circuitry is configured
to determine if a location of the mechanic's place of business is within a predetermined distance of a location of the user device, and
transmit the request for the mechanic to service the vehicle to at least one local mechanic device corresponding to the location of the mechanic's place of business.

3. The server according to claim 1, wherein the circuitry will not accept bids from the local mechanic device when the bidding time limit is reached.

4. The server according to claim 1, wherein the request for the mechanic includes a user profile, the user profile being a post including information corresponding to the request.

5. The server according to claim 4, wherein the user profile includes a profile image of a user of the user device and user profile information.

6. The server according to claim 5, wherein the user profile information includes a name of a user of the user device, a make of the vehicle, a model of the vehicle, a location of the vehicle, a meeting date, a meeting time, and services requested.

7. The server according to claim 1, wherein the bid can include a mechanic profile.

8. The server according to claim 7, wherein the mechanic profile includes a price to complete the requested services, a profile image of the mechanic, and mechanic profile information.

9. The server according to claim 8, wherein the mechanic profile information includes a name of the mechanic, a number of years of experience, a location of the mechanic device, a location of the mechanic's place of business, certifications, and a rating.

10. The server according to claim 1, wherein the circuitry automatically receives from the vehicle a request for a mechanic when an alert from an auto-diagnostic feature included in the vehicle is detected.

11. The server according to claim 10, wherein the request for the mechanic includes information about a mechanical malfunction of the vehicle, vehicle information, and information of the owner of the vehicle.

12. The server according to claim 1, wherein the circuitry is configured to update the bid made by the local mechanic device when another local mechanic device overrides the bid.

13. The server according to claim 1, wherein the circuitry is configured to initiate virtual communication over a network between the user device and the local mechanic device, in response to receiving an input from the user device and/or the local mechanic device.

14. The server according to claim 1, wherein the server is communicably coupled to a database.

15. The server according to claim 14, wherein the database stores one or more user profiles, one or more mechanic profiles, and transaction history between the user device and the at least one local mechanic device.

16. The server according to claim 15, wherein the circuitry is configured to access a user profile stored in the database and transmit the user profile to the local mechanic device to display the user profile on the at least one local mechanic device.

17. The server according to claim 16, wherein the circuitry is configured to access a mechanic profile stored in the database and transmit the mechanic profile to the user device to display the mechanic profile on the user device.

18. A method of matching a user device with a mechanic device comprising:
receiving an on-demand request from a user device for a mechanic to service a vehicle;
determining, via a processing circuitry, if at least one mechanic device is within a predetermined distance of a location of the user device;
transmitting the request for the mechanic to service the vehicle to at least one local mechanic device corresponding to at least one mechanic device within the predetermined distance, wherein the request activates programming within the at least one local mechanic device within the predetermined distance to cause the at least one local mechanic device to display the request;
receiving, from the at least one local mechanic device and in response to receiving the request, one or more bids to service the vehicle;
determining, via the processing circuitry, if a bidding time limit has been reached for the at least one local mechanic device within the predetermined distance;
transmitting, in response to the bidding time limit being reached, the bids to the user device, which activates programming within the user device to cause the bids to display on the user device; and
receiving a selection, from the user device and in response to receiving the bids, for one of the bids from the at least one mechanic device.

19. A system comprising:
a server;
a database;
at least one user device;
at least one mechanic device; and
a network communicably coupling the server, the database, the at least one user device, and the at least one mechanic device,
wherein the server includes circuitry configured to
receive an on-demand request from a user device for a mechanic to service a vehicle,
determine if at least one mechanic device is within a predetermined distance of a location of the user device,
transmit the request for the mechanic to service the vehicle to at least one local mechanic device corresponding to at least one mechanic device within the predetermined distance, wherein the request activates programming within the at least one local mechanic device within the predetermined distance to cause the at least one mechanic device to display the request,
receive, from the at least one local mechanic device and in response to receiving the request, one or more bids to service the vehicle,
determine if a bidding time limit has been reached for the at least one local mechanic device within the predetermined distance,
transmit, in response to the bidding time limit being reached, the bids to the user device, which activates programming within the user device to cause the bids to display on the user device, and
receive a selection, from the user device and in response to receiving the bids, for one of the bids from the at least one mechanic device.
